(19) United States
(12) Patent Application Publication
(10) Pub. No.: US 2022/0136080 A1
(43) Pub. Date: May 5, 2022

(54) METHOD FOR RECOVERING GOLD AND COPPER FROM ELECTRONIC COMPONENTS

(71) Applicant: Francesca GIULIANO, Trinitapoli (Barletta Andria-Trani) (IT)

(72) Inventor: Gaetano FRISI, Trinitapoli (Barletta Andria-Trani) (IT)

(21) Appl. No.: 17/434,224

(22) PCT Filed: Feb. 21, 2020
(86) PCT No.: PCT/IB2020/051467

§ 371 Date: Aug. 26, 2021

(30) Foreign Application Priority Data
Mar. 12, 2019 (IT) 102019000003555

(51) Int. Cl. C22B 11/00; C22B 15/00; C22B 3/10; C22B 3/06

(52) U.S. Cl. CPC C22B 11/046; C22B 3/065; C22B 3/10; C22B 15/0067

(57) ABSTRACT

A method for recovering gold from electronic components includes a first macro-step of dissolving gold and copper from the electronic components using an aqueous solution comprising HNO₃ concentrated in a percentage varying from 28% to 38% and concentrated HCl in a percentage varying from 15% to 25%. A second macro-step includes adding KOH to the obtained solution to bring it to a pH between 0.5 and 0.9. A third macro-step includes adding to the solution obtained in the second macro-step an amount of ascorbic acid dissolved in water equal to the amount of gold hypothetically present in a sample of the first macro-step, multiplied by a factor ranging between 1.5 and 3, causing precipitation of gold, which is separated from the solution and made available in powder form in a fourth macro-step.

The present invention is in the field of methods for recovering gold and copper, in particular from electronic components.

### STATE OF THE ART

When one discusses the recovery of metals from electronic circuit boards, one must immediately abandon the myth of easy gold and considerable earnings.

In effect, the costs for the necessary acid solutions and other reagents to be used, the costs for eliminating gaseous emissions and for wastewater treatment, and above all the cost of electronic circuit boards containing less and less gold, must be taken into account.

Another consideration to be made is that in general it is not suitable to carry out the recovery of other metals present, since the costs to obtain them exceed the corresponding revenue and would therefore only be a waste of reagents.

Copper, for example, which is the most abundant metal, is sold at a price of 5-6 euro/kg, if very pure, and yet requires recovery costs which are higher than revenues or, to be optimistic, equal thereto.

It follows that the only metal to be recovered is gold, since it has a very attractive selling price (35-40 euro/g).

The gold on electronic circuit boards is found in small quantities and only at particular points, for example on the comb connectors of RAM, VIDEO, AUDIO, GRAPHICS cards, on the connectors of other circuit boards and especially on the small but numerous pins of the CPU.

Therefore, a need is felt for a method for recovering gold from electronic circuit boards that is both technically effective and economically viable.

### OBJECT AND SUBJECT-MATTER OF THE INVENTION

The object of the present invention is to provide a method for recovering gold from electronic components or other elements or materials containing gold which solves all or part of the problems of the prior art.

A method according to the accompanying claims is the subject-matter of the present invention.

### DETAILED DESCRIPTION OF EXAMPLE EMBODIMENTS OF THE INVENTION

### List of Figures

The invention will now be described for illustrative but non-restrictive purposes, with particular reference to the drawings of the accompanying figures, wherein:

FIG. 1 shows the macro-steps of an embodiment of the method according to the invention.

It is specified here that elements of different embodiments may be combined to provide additional embodiments without limitations respecting the technical concept of the invention, as the person skilled in the art understands without difficulty from that which is described.

The present description further refers to the prior art for its implementation, with respect to undescribed detailed features, such as elements of minor importance usually used in the prior art in solutions of the same type.

When an element is introduced, it is always intended to mean “at least one” or “one or more”.

When listing elements or features in this description, it is understood that the invention “comprises” or alternatively “is composed of” such elements.

### Embodiments

As mentioned above, gold is mainly present in electronic and electrical circuit boards and components, but only in some areas thereof. To make the recovery process more economical it is thus advisable to use only the aforesaid parts of the circuit boards and not the entire board, which would require significant volumes of acid solutions. Only some RAM cards that have yellow-gold dots or parallel lines may be used in full, taking care to cut them into small pieces.

The prerequisite for considering a reasonable profit margin from the recovery of gold is that one does not pay for the electronic circuit boards.

The method of the invention has been conceived generally advantageously for those companies that already have the recovery systems for the aforesaid circuit boards and may therefore count on a certain continuity of processing, having the necessary equipment already available.

In the following, the percentages of the components of a solution are percentages by volume, while the percentages of solid substances are percentages by weight.

### Formation of the Sample

The material to be processed, which we will call the sample, is obtained by cutting off the comb connectors of RAM, VIDEO, AUDIO cards and all other types of circuit boards with gold-plated comb connectors originating from any electronic device. The strips of the connectors, obtained by appropriately cutting the plated area, are in turn cut into sufficiently small pieces (advantageously 2-3 cm²). Some RAMS may be used in full because they have plated areas on almost the entire surface and are therefore preferably cut into 5 or 6 pieces. One must include in the sample all those parts of any board that have yellow-gold-colored areas or dots. CPUs may be used, taking care to remove the copper plate from the back, or in their entirety if they are ceramic or by cutting them into two parts. This results in a significant volume reduction for the same amount of recoverable gold. CPU plates are made of pure copper and are therefore a cost-free recovery.

Although reference is made in the present description to the recovery of gold from electronic components, it should be understood that the method of the present invention also works in the recovery from other types of samples or elements, as the chemical reactions are generally not affected. Possible elements comprise gold-plated products.

### Gold Recovery Method

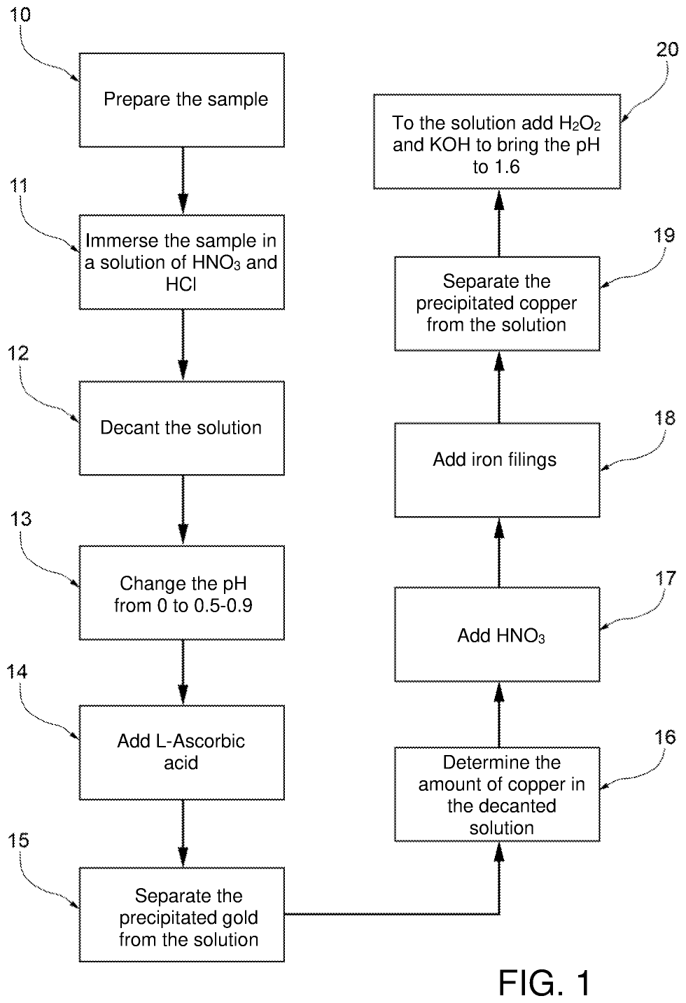

Referring to FIG. 1, the present invention concerns a method for the recovery of gold from electronic components, comprising the execution of a first macrostep (blocks 10 to 12), starting with an appropriately prepared sample of electronic components, dissolution of the gold from said electronic components using an aqueous solution comprising HNO₃ in a concentration ranging from 28 to 38% and HCl in a concentration ranging from 15 to 25% (the rest advantageously is water, for example 28 ml of HNO₃, 20 ml of HCl and 52 ml of water). Subsequently, a second macrostep (block 13) is performed, which comprises the addition of KOH to the solution obtained to bring it to a pH between 0.5 and 0.9. The third macrostep (block 14) provides for adding to the solution obtained in the second macrostep an amount of ascorbic acid dissolved in water at least equal to the amount of gold hypothetically present in said sample of step A, multiplied by a factor ranging between 1.5 and 3. This results in the precipitation of the gold, which in a fourth macrostep (15) is separated from the solution and made available in powder form.

In general, in this description, when one speaks of KOH, it is understood as equally possible to use other alkaline substances, either individually or in combination, such as NaOH. KOH is preferred because the final solution after the gold has been removed is not harmful as a fertilizer, unlike that obtained for example with NaOH.

The Inventor has determined experimentally that the amount of gold that is recovered may vary from 0.06 to 0.1% of the weight of the sample and thus from the weight of the sample one may determine the amount in grams of ascorbic acid to be dissolved in a certain volume of water (it dissolves easily). For example a sample of about 200 g, assuming a percentage of gold of 0.08%, would require 160×2=320 mg of ascorbic acid, rounded up to 350-400 mg.

Subsequently, the purity of the separated gold may be increased by placing it in an aqueous solution of 1:1 HNO₃ and 1:1 HCl and, after solubilization, adding ascorbic acid again, which precipitates the gold which is then separated from the solution.

The following describes these macro-steps in more qualitative and quantitative detail.

Starting from the prepared sample, a diluted acid solution is added, which here we shall call “regia solution” to differentiate it from “aqua regia”, which uses concentrated acids.

The “regia solution” is prepared with 33% HNO₃ concentrate (as available on the market, i.e. about 67%), 20% HCl concentrate (as available on the market, i.e. about 37%) and 47% H₂O.

A volume of this solution sufficient to fully cover the material in reaction is used. According to the experimental practice of the invention, the volume of solution to be used is about 1.1 (1.05 to 1.15) times the weight of the sample reduced in volume as described above:

$${V}_{solution} = Weight \times 1.1$$

For example, if one has 1 kg of sample, one will need to use 1100 ml of solution. A vessel (also called a “reaction vessel”) with the sample is placed in a cold water bath and the prepared regia solution is added to the sample. The volume of solution to be added in effect depends on the free space that is determined between the various pieces of the sample, which, if they are small, leave a certain volume, and if they are rather large, leave a larger space between them, i.e. a greater volume to be filled whereby more solution is needed.

Advantageously, the reaction vessel is closed by an apparatus that conveys the reaction gases into a separate vessel of water, thus preventing them from dispersing into the air.

The sample is left to react for 8 to 12 minutes (e.g. 10 minutes), then it is removed from the water bath and left at room temperature for 27-40 minutes. The cold water bath is necessary to maintain the reaction temperature within certain values (50-55° C.) and thus avoid the solubilization of part of the resin in the pieces of circuit boards of the sample. The temperature of the bath is lower than room temperature, preferably between 5 and 10° C., which may be determined in any case as a function of the intensity of the exothermic reaction.

After 40-45 minutes, the “regia solution” has solubilized enough copper and all the gold present in the mixture-sample, behaving like aqua regia but having a different composition with rather diluted concentrations of HNO₃ and HCl, and a different percentage ratio with a prevalence of nitric acid, necessary to solubilize also the copper.

With such a diluted solution, the acid attack on the two metals proceeds in a controlled way, it is not turbulent, only somewhat lively in the first 3-4 minutes; the development of the reaction gases proceeds with moderate speed, and it is sufficient for safety to operate under a hood, using an apparatus that conveys the gases into a vessel of water with consequent formation of usable diluted HNO₃ and HCl, with the addition of appropriate amounts of the corresponding concentrated acids, in another production process. In this way the gases are recovered in the water with the formation of a reusable solution, thus avoiding their dispersion in the air.

The solubilization reactions that occur in solution are:
For Gold:

Au+4Cl⁻→AuCl₄⁻+3e⁻(formation of the chloroauric complex)

3NO₃⁻+6H⁺+3e⁻→3NO₂+3H₂O
namely:

Au+4Cl⁻+3NO₃⁻+6H⁺→AuCl₄⁻+3NO₂+3H₂O

Au+4HCl+3HNO₃→HAuCl₄+3NO₂+3H₂O
For Copper:

Cu+2NO₃⁻+4H⁺4H⁺→Cu⁺⁺+2NO₂+2H₂O

### Processing of the Solution

A green-blue solution is obtained, which is left to precipitate and is decanted to a different vessel. At least one wash (preferably two washes) of the sample with water is carried out to collect all residual solution adhering to the pieces of the sample. The washing water is added to the decanted solution, noting (measuring) its total volume V_{T}.

The total unfiltered solution is subjected to boiling until the volume is reduced to half or three-quarters of the volume, which is noted, and, after cooling, water is added to bring the total volume, in the first case, back to a value equal to the initial volume, and in the second case, water is added to bring the total volume to a value of 1.5 times the initial volume.

In the second case, for example, a solution with an initial volume of 400 ml is boiled to reduce it to 300 ml. Water is added until the new volume has reached 600 ml. In practice, a volume of water is added equal to the volume of the solution remaining after boiling.

The solution may also be boiled to a predetermined value between half volume and three quarters volume with subsequent addition of water to bring the final volume within the range between a volume equal to the initial volume and a volume equal to 1.5 times the initial volume.

Boiling has two advantages. The first is that it has a destructive effect on the nitric acid, which is an oxidizer that would hinder the reduction of the auric ion (Au⁺⁺⁺) to metallic gold by the reducing agent (specified below). The second is that it allows for the amount of potassium hydroxide, which is added later to reduce the acidity of the solution, to be decreased.

After boiling, to further reduce the oxidizing effect of the nitrate ion present and thus its ability to inhibit the reduction process of the gold, the excessive acidity present is reduced by adding a 40% potassium hydroxide KOH solution (generally 30 to 50% of a hydroxide, but any value that brings the solution to the desired pH is fine), which brings the pH from practically zero to a value between 0.5 and 0.9. While adding KOH, it is advantageous to stir to avoid the formation of copper hydroxide particles. Increasing the pH to 0.5-0.9 eliminates the ability of the nitrate ion to inhibit the reduction of the gold with ascorbic acid which will be added later, as explained hereinafter.

From the point of view of the previous considerations and returning to the case of boiling to reduce the initial volume to three quarters volume, it is to be considered that, if on the one hand the boiling is less prolonged than boiling to half volume, it is also true that the greater addition of water to increase the total volume by 50% leads to a slight increase in pH and therefore to a savings in the addition of KOH to bring the pH to a value between 0.5 and 0.9.

In the Inventor's experiments, it was found that the volume of hydroxide to be added may vary between 14 and 23%, preferably between 16 and 19% of the initial volume of the solution. In any case, the important data to be kept under control, the guiding parameter for gold precipitation, is the pH.

During the addition of KOH it is thus advantageous to monitor the changes in pH (the measurements should be taken at room temperature).

Once the pH in the aforesaid range has been reached, the solution is filtered, and L-ascorbic acid (C₆H₈O₆) dissolved in water, is added with a certain excess (about double, generally between 1.5 and 3 times) with respect to the amount of gold presumably present, which, after about thirty seconds and preferably with stirring, precipitates the gold in the form of a fine brown powder, which then with heating takes on a yellow-brown color.

The reaction is as follows:

2 HAuCl₄+3 C₆H₈O₆→2 Au+8HCl+3 C₆H₆O₆

Ascorbic acid reduces the Au⁺⁺⁺ ion to metallic gold by in turn oxidizing to dehydroascorbic acid. As may be seen, the ratio of gold to ascorbic acid is 1:1.5. The general reducing property of L-ascorbic acid is known, but to the Inventor's knowledge it has never been used as a gold-reducing agent in recovery projects. The experiments carried out by the Inventor have shown that L-ascorbic acid is very selective in the reduction of the auric ion.

The amount of gold for the calculation of L-ascorbic acid to be added is determined hypothetically or by any other method in the art suitable for the purpose.

As far as filtration is concerned, it may be done for example with laboratory filter paper (50×50 cm−77 g/m²). The impurities of the used circuit boards are eliminated: pieces of adhesives, pieces of paper, black dots from the back of the CPUs, opalescence. It is preferable, although not mandatory, to filter to avoid obtaining impure (copper and) gold.

After the addition of the excess ascorbic acid and the subsequent precipitation of the gold as a fine powder, the precipitate is allowed to settle for at least one hour, preferably at least 2 to 3 hours, after which time the blue solution containing the copper is decanted and set aside in an additional vessel.

Preferably, the precipitate of powdered gold is washed with distilled water once or twice and allowed to precipitate again. This time the precipitation is faster. The overlying water is slowly decanted and is removed, and the gold dust is dried in the furnace at 200° C. or more (preferably up to 300° C.) or on a heating plate. The gold may alternatively be separated by filtration and calcination of the filter.

To recover (optionally) the copper, to the solution that has been decanted and set aside after the precipitation and recovery of the gold, which we will call “Cu solution” or “copper solution”, iron filings or powder are added (block 18 in FIG. 1) that reduces the Cu⁺⁺ to metal, in turn oxidizing to Fe⁺⁺:

Fe+Cu⁺⁺→Fe⁺⁺+Cu

The amount of iron to be added is the stoichiometric quantity with respect to copper, i.e. equal to the amount of copper divided by 1.138, which is the ratio between the atomic weights of copper and of iron. The amount of copper is determined photometrically (block 16 in FIG. 1, see below).

The reaction is one of oxidation-reduction and in practice the copper is obtained as if it were in a short-circuited galvanic cell, wherein the oxidation and reduction reactions do not take place in separate compartments, but with a direct exchange of electrons. The system under these conditions is obviously exothermic. In the case of copper solutions with considerable volumes, the heat that develops is significant (a temperature of 40-45° C. may be reached) and to remedy this, external cooling may be used, for example a cold water bath, with stirring necessary to allow the distribution of the heat and to facilitate the reaction between iron and copper.

The reaction between the two metals, unlike the recovery of copper by electrolysis, has the advantage of being a direct reaction which is very fast and does not require electrolytic equipment.

In the copper solution (Cu solution), before adding the iron powder, 1:1 HNO₃ equal to 5-10% (for example 8%) of the total volume of the solution is poured (block 17 in FIG. 1). This addition significantly lowers the pH and allows a very rapid precipitation of the copper. In fifteen minutes virtually all the copper is at the bottom of the vessel with a clear separation from the solution which is decanted very slowly.

At this point, the precipitated copper is separated from the solution obtained (block 19 in FIG. 1). Advantageously, the precipitated copper is washed with water immediately and heated to boiling. As soon as the boiling starts, the heat is removed and it is left to precipitate, for example for 15-20 minutes. The washing water is slowly decanted and added to the previous solution. The boiling of the washing water is necessary to greatly accelerate the precipitation of the copper, which would take longer if cold.

The decantation of the solutions must be done very slowly to avoid pouring the copper out with them.

The copper is preferably dried on a plate or in a furnace and weighed, thus obtaining the experimental recovered amount, which is slightly less than the one actually present in the solution. From the comparison of these two data the yield obtained is determined. Subsequently its purity is also determined.

The decanted solution contains Fe⁺⁺, NO₃⁻, K⁺ ions and is therefore a by-product that may be further processed and finally used as a fertilizer based on iron, nitrogen and potassium.

In this way, copper is obtained with a yield of around 94-95% and a purity of around 96%.

The decanted solution is processed with 10 volume hydrogen peroxide H₂O₂ (equivalent to 3%) to oxidize Fe⁺⁺ to Fe⁺⁺⁺.

The oxidation reaction is:

2Fe⁺⁺+H₂O₂+2H⁺→2Fe⁺⁺⁺+2H₂O

To establish the amount of hydrogen peroxide to be added to oxidize all the Fe⁺⁺ to Fe⁺⁺⁺ the weight of the iron added is multiplied by the factor 0.3044 which is the ratio between the equivalent weight (E.W.) of the H₂O₂ and the E.W. of the Fe⁺⁺ in the reaction written above and thus is 17/55.84=0.30444.

The result is multiplied by 100 and divided by 3, which is the percentage of H₂O₂.

For example, if 10.5 g of iron have been added to the copper solution, the calculation is:

$$10.5 \times 0.3044 = 3.196 \times 100 = 319.6 / 3 = 106.5 cc$$

of hydrogen peroxide to be added.

However, it is expedient to add the hydrogen peroxide slightly in excess to compensate for any instability in the H₂O₂ titer.

The solution takes on a red-brown color typical of iron hydroxide and since the pH of the solution is about 1, 20% potassium hydroxide KOH is added (in general 15 to 25%) until the pH value is raised to 1.6 (block 20 in FIG. 1; generally 1.5 to 1.9). After each addition of caustic potash, the pH should be checked (at room temperature). The solution is then diluted with water in the ratio of 1:1.5, and a pH of 2.1 is obtained. If it is diluted in the ratio of 1:2, a pH of 2.2 is obtained (generally the dilution will lead to a pH between 1.9 and 2.3). This has resulted in a good liquid fertilizer containing nitrogen, potassium and iron as iron nitrate Fe(NO₃)₃ and potassium nitrate KNO₃.

At the end of the recovery process the following are obtained:

Gold (0.060%-0.1%)—Copper (7%-12%)—Final solution of nitrate, iron and potassium (pH=2.1-2.2)

### Examples of Embodiment of the Method

Below are the results obtained in five experiments carried out by the Inventor, following the method described and using samples of circuit boards that are different in composition and weight. It is clear that, depending on the composition of the sample, slightly different results will be obtained. This does not affect the repeatability and reliability of the method.

The reagents used were: Nitric acid 67%—Hydrochloric acid 36%—Ammonia—Potassium hydroxide—L-Ascorbic acid—Hydrogen peroxide 10 vol. (3%)—Fine iron filings or iron powder.

For each recovery cycle only 1.5 ml of 1:1 diluted ammonia is used and therefore no such volume was taken into account in the calculation of costs, which will be provided below after the description of the experiments.

### Experiment 1

Sample weight=141 g composed of 5 CPUs (cut in half); 12 RAM cards including 5 whole cards cut into 5 or 6 pieces, only the connectors of the other 7; 12 video, audio and other cards (only the connectors of these cards)
Gold recovered=0.06% of the weight of the sample, i.e. 0.088 g

### Purity=98.0%

Copper recovered=9.44% of the sample

### Yield=95%; Purity=95.5%

Total copper recovered=13.55 g+84.9 g from CPU plates=98.45 g
The experimental values reported have been obtained by following the operations described hereinafter.

### Part A

A sample is prepared composed of the parts of electronic circuit boards containing gold. An aqueous solution composed of 28% HNO₃ and 15% HCl is added to the sample.

The vessel is immersed in a cold water bath (generally, and for all the examples, at a temperature below room temperature, expediently between 5 and 10° C.) for 8-12 minutes. After this time, the vessel is removed from the bath and left at room temperature for another 35-40 minutes. After a total time of 45-52 minutes during which the gold and most of the copper has been solubilized, the solution is decanted into another vessel, taking care to wash twice with water to remove any portions of solution adhering to the pieces of circuit boards. The washing water is added to the decanted solution by measuring the volume V thereof.

### Part B

The solution is boiled until the initial volume V is reduced to half; it is cooled and water is added to bring the volume back to the initial value. 30% KOH is added to bring the pH to 0.5. The solution is filtered to which is added an amount of ascorbic acid at least equal to 1.5 times the weight of gold presumably present in the solution (generally, at least 1.5-3 times for all the examples).

After at least two hours the powdered gold precipitates and is then separated from the solution containing the copper.

### Part C

The amount of Cu present in the solution containing the copper called the “copper solution” is determined, for example with the photometric method described in the present application. An amount of 1:1 HNO₃ equal to 5% of the volume of the copper solution is added and then the stoichiometric quantity of iron powder or fine iron filings is added, which reduces the Cu⁺⁺, causing it to precipitate as metallic copper. The solution is decanted, and the precipitated copper is separated.

### Part D

To the decanted solution is added 2% hydrogen peroxide and then 15% KOH in an amount such as to bring the pH to between 1.4 and 1.6. Water is added to bring the pH into the range 2.0-2.2.

### Experiment 2

Sample weight=248.5 g composed of:
11 CPUs (cut in half);
18 RAM cards, 5 being whole and cut into 6 pieces;
only the connectors from the other 13;
29 video, audio, graphics and other types cards of (of these cards, only the connectors).
   Gold recovered=0.096% of the weight of the sample, i.e. 0.240 g

### Purity=97.2%

Copper recovered=9.27% of the sample

### Yield=96%

### Purity=95%

Total copper recovered=22.11 g+198 g from the plates of the CPUs=220 g
The experimental values reported have been obtained by following the operations described hereinafter.

### Part A

A sample is prepared as described above and an aqueous solution composed of 30% HNO₃ and 18% HCl is added. The reaction vessel is immersed for 10 minutes in a cold water bath, after which it is left at room temperature for another 30-35 minutes. After this time, during which all the gold and most of the copper has been solubilized, the green-blue solution is decanted to another vessel and is washed twice with water to remove residues of solution. The washing water is added to the first solution, measuring the total volume V thereof.

### Part B

The solution is boiled until its initial volume V is reduced to half; water is added until the volume is restored to the initial value V. 35% KOH is added until the pH value is brought to 0.6. The solution is filtered to which is added an amount of ascorbic acid dissolved in water, equal to twice the weight of gold presumably present in solution. After two hours or more the powdered gold precipitates and is then separated from the solution.

### Part C

In this solution the amount of Cu is determined by a suitable method, for example with the photometric method described hereinafter. An amount of 1:1 HNO₃ equal to 7% of the volume of the solution is added, and then the stoichiometric quantity of iron powder is added to reduce the Cu⁺⁺ to metallic copper. The solution is decanted, the precipitated copper is separated and is washed and dried.

### Part D 3% H₂O₂ is added to the decanted solution and subsequently 18% KOH is added in an amount such as to bring the pH to around 1.6. Water is added until a pH equal to 2.0-2.1 is reached.

### Experiment 3

Sample weight =243.2 g composed of
10 CPUs (cut in half);
15 RAM cards, 5 of which are whole and cut into 6 pieces; only the connection areas of the others;
15 video, audio, graphics cards, etc., of these cards only connection areas.
   Gold recovered=0.099% of the weight of the sample, i.e. 0.241 g

### Purity=99%

Copper recovered=8.28% of the sample

### Yield=94%

### Purity=95%

Total copper recovered=19.33 g+284 g from the plates of the CPUs=303 g

The experimental values reported have been obtained by following the operations described hereinafter.

### Part A

An aqueous solution composed of 33% HNO₃ and 20% HCl is added to the sample prepared as described above. The vessel is immersed in a cold water bath and left for 10 minutes. It is removed from the bath and kept at room temperature for another 35 minutes. After this time, the solution is poured into another vessel, and the pieces of circuit boards are washed twice with water which is added to the solution, and the volume (V) thereof is measured.

### Part B

The solution is boiled until it is reduced to half its volume. Water is added to restore the volume to the initial value. 40% KOH is added to bring the pH to 0.7. The solution is filtered to which is added ascorbic acid in water equal to 2.5 times the weight of the gold believed to be present in solution. After 2 hours or so, the gold precipitates and then separates from the solution.

### Part C

In this solution obtained from Part B, the copper is determined with the method of the invention, an amount of 1:1 HNO₃ equal to 8% of the volume of the solution is added and then the stoichiometric quantity of iron powder. The copper precipitates almost instantaneously. The solution is decanted, the precipitated copper is separated and is washed and dried.

### Part D

4% H₂O₂ is added to the decanted solution and then 20% KOH to bring the pH to 1.6-1.7. Water is then added until a pH of around 2.0-2.2 is obtained.

### Experiment 4

Sample weight=254.1 g composed of
10 CPUs (cut in half);
6 whole RAM cards cut into 6 pieces;
15 RAM cards (connection zone only);
31 video, audio, graphics cards, etc.; of these cards only connection zones.
   Recovered gold=0.071% of the weight of the sample, i.e. 0.181 g

### Purity=97.2%

Recovered copper=7.78% of the sample

### Yield=95%

### Purity=96.5%

Total recovered copper=18.98 g+176 g from the plates of the CPUs=195 g
The experimental values reported have been obtained by following the operations described hereinafter.

### Part A

An aqueous solution composed of 35% HNO₃ and 22% HCl is added to the prepared sample. The vessel is immersed in a cold water bath for 10 minutes, then removed from the bath and left at room temperature for another 35 minutes. After this time, the solution is decanted and the sample is washed twice with water, which is added to the decanted solution, measuring the volume (V) thereof.

### Part B

The solution is boiled to reduce its volume to half. Water is added to restore the volume to the initial value. 45% KOH is added to bring the pH value to 0.8. The solution is filtered to which is added ascorbic acid dissolved in water equal to 3 times the weight of the gold which is believed to be present in solution. After 2 or 3 hours the powdered gold precipitates and is then separated from the solution.

### Part C

The copper present in this solution is determined, an amount of 1:1 HNO₃ equal to 9% of the volume of the solution is added and then the stoichiometric quantity of the iron powder. The copper is stirred and precipitated. The solution is decanted, and the precipitated copper is separated.

### Part D

To the decanted solution is added 4% H₂O₂ and immediately after 22% KOH to bring the pH to 1.6-1.7. Water is then added to bring the pH to 2.0-2.2.

### Experiment 5

Sample weight=217.5 g composed of 5 CPUs (cut in half) 19 RAM cards, of which 8 whole cards are cut in 6 pieces. Of the other 11, only the connectors 15 of the video, audio, graphics and other types of cards (of these only the connectors)
Gold recovered=0.092% of the weight of the sample, i.e. 0.201 g

### Purity=97.0%

Copper recovered=11.29% of the sample

### Yield=94.1% Purity=95.8%

Total recovered copper=23.1 g+85.1 g from CPU plates=108.2 g

The experimental values reported have been obtained by following the operations described hereinafter.

### Part A

An aqueous solution containing 38% HNO₃ and 25% HCl is added to the sample. The vessel is immersed in a cold water bath for 10 minutes. After this time it is left at room temperature for another 35 minutes, after which the solution is decanted, and the sample is washed twice with water, which is added to the decanted solution, measuring the volume (V) thereof.

### Part B

The solution is boiled until the volume V is reduced to half. Water is added to bring the volume back to the initial value. 50% KOH is added to bring the pH to 0.9. The solution is filtered to which is added ascorbic acid dissolved in water equal to three times the weight of the gold which is believed to be present in solution. After 2 or 3 hours the gold precipitates and is then separated from the solution.

### Part C

The copper present in this solution is determined. An amount of 1:1 HNO₃ equal to 10% of the volume of the solution is added, and then the stoichiometric quantity of iron powder is added. The metallic copper is stirred and precipitated. The solution is decanted, and the precipitated copper is separated.

### Part D

To the decanted solution is added 5% H₂O₂ and immediately after 25% KOH to bring the pH into the range of 1.6-1.7. Water is then added to obtain a pH of 2.0-2.2.

Some considerations may be made regarding the experiments described.

Parts C and D of the method are always optional, as they are intended for recovering the copper.

The experiments have shown the feasibility of the recovery method according to the invention at different concentrations of the “regia solution” in the range of 28-38% HNO₃ concentration and 15%-25% HCl concentration. The regia solution is the main reagent of the entire chemical process of cold recovery of gold. It has been noted that for lower concentrations, solubilization is practically impossible.

Another consideration that should not be overlooked is that if the maximum concentration limits for the two acids HNO₃ and HCl used in the method are exceeded, this could significantly affect the cost/revenue ratio, which is the driving force behind any productive activity.

It should be taken into account that very concentrated acid solutions require higher concentrations of KOH to stabilize their pH around a certain value and therefore would have another negative impact on the cost/revenue ratio.

The environmental implications related to the development of the chemical hydrometallurgical recovery process have been taken into account in this work as mentioned above.

By operating according to the method described, there is no emission of gases into the atmosphere because the gas-conveying equipment solubilizes them in water with the formation of diluted nitric and hydrochloric acid, recovered for subsequent reuse.

The Inventor believes to have also found a valid technical solution for a useful recovery of the final solution, which is a by-product that may be used by companies that produce fertilizers. The final solution may be used with good results in fertigation, as it contains excellent nutrients such as nitrogen (nitrate), potassium and iron, or, if diluted, may be used as a foliar fertilizer.

There is therefore no waste to dispose of.

Substances recovered: GOLD (high purity) COPPER (good purity)

By-product: LIQUID FERTILIZER.

### Method to Increase the Purity of the Gold

As previously stated, the recovered gold has an average purity of between 97 and 99%, but if one wants to have a sample with the highest purity, i.e. about 99.97%, one may optionally proceed as follows.

Assuming 2 grams of 96% gold in powder or small flakes, these are treated with 40 ml of a solution consisting of 10 ml of 1:1 HNO₃ and 30 ml of 1:1 HCl. In general, HNO₃ will be present between 25 and 35% and HCl between 75 and 65%.

The mixture is heated until boiling and as the gold gradually dissolves, the solution turns yellow. Boiling is preferably maintained for 5 minutes.

When all the gold has solubilized, it is cooled, and the solution is diluted with distilled water, in the example up to 150 ml (even up to 4 times the initial volume).

It is filtered, advantageously, washing the filter afterwards to remove residues of solution. To the yellow and clear filtered solution the reducing agent L-Ascorbic acid is added, which is dissolved in water at 1:1.5 with respect to the gold present in the mixture (estimated), which, after a few seconds and with stirring, make very pure powdered gold precipitate.

The reaction is:

2HAuCl₄+3C₆H₈O₆→2Au+8HCl+C₆H₆O₆

As may be seen from the reaction, the weight ratio between gold and ascorbic acid is 1:1.5 and therefore the ascorbic acid to be added must be slightly higher than this ratio. Therefore, for 2 grams of gold a little more than 3 grams of ascorbic acid is added.

The solution is stirred and allowed to precipitate.

When the precipitation is complete (about 1 hour), the colorless solution is decanted very slowly and the gold remaining at the bottom of the vessel is removed by heating, for example on a plate (at least 200-300° C.), obtaining gold of high purity (99.9%).

### Photometric Determination of the Copper

In the experimental work that led to the invention, 1 ml of Cu solution, the total volume of which we noted, is diluted to 1:50 (generally between 1:45 and 1:65) with distilled water obtaining another solution, very diluted, which we shall call “sample solution”. For example, 1.5 ml is taken from this sample solution and it is poured into a test tube very slowly. 1.5 ml of NH₄OH (1:1) is added. This forms the blue-colored cupriammonic complex ion cu(NH₃)₄^{++,} the intensity of which is directly proportional to the amount of copper present. The likely reaction is:

Cu(NO₃)₂+4 NH₄OH→Cu(NH₃)₄(NO₃)₂+4H₂O

The test tube is further centrifuged to obtain a clear sample, as a little iron hydroxide is always deposited at the bottom.

A “standard solution” of 80 mg of pure copper (99.9%) is then prepared in 100 ml of water as follows: 80 mg of pure copper is weighed and dissolved in 4-5 ml of 1:1 HNO₃. When all the copper has been solubilized, distilled H₂O is added up to 100 ml. This solution is here called the “standard solution”. From this standard solution, 1.5 ml is sampled and poured slowly into a test tube to which 1.5 ml of NH₄OH (1:1) is added.

The photometric reading at 600 nm of the two prepared samples is performed and two optical density values are obtained: Sample O.D. and standard O.D. The calculation is:

$$Sample O . D . / Standard O . D . \times 0.080 \times 50 = \% of copper ( g / 100 ml )$$

Knowing the percentage of copper and the total volume of the Cu solution, the total amount of copper present is determined and consequently the amount of iron to be added to the solution to precipitate the copper according to that which has been stated above, i.e. Fe=Cu/1.138.

For example, 60 g of copper requires 60/1.138=52.72 g of iron for its precipitation.

### Cost/Revenue Ratio

As far as the costs and revenues of the gold and copper recovery method are concerned, the values shown in the table are approximate, but provide guidance on the feasibility of the entire project.

Costs and revenues were calculated on the basis of the results of the experiment no. 4 reported above and by taking into account the prices of commercial technical products available on the online market. The following table shows the average prices of the reagents found on the market, including shipping costs.

| Molecule | Percentage | Cost (Euro) |
|---|---|---|
| HNO₃ | 65% | 5/liter |
| HCl | 36% | 4/liter |
| KOH (drops or flakes) | | 4/kg |
| ASCORBIC ACID | | 23/900 g |
| (powder) | | |
| H₂O₂ | | 3/liter |
| IRON (powder) | | 5/kg |

The table of costs and revenues is therefore as follows:

| COSTS | | | | REVENUES | |
|---|---|---|---|---|---|
| Molecule | Quantity | | Price (Euro) | Element | Price (Euro) |
| HCl | 56 | ml | 0.224 | GOLD | 6.33 |
| HNO₃ | 92.4 ml + 19.2 ml | | 0.558 | COPPER | 1.07 |
| 40% KOH | 80 ml + 25 ml | | 0.420 | | |
| ASCORBIC | 0.400 | g | 0.010 | | |
| ACID | | | | | |
| H₂O₂ | 190 | ml | 0.570 | | |
| IRON | 18 | g | 0.09 | | |
| (powder) | | | | | |

TOTAL

| | |
|---|---|
| 1.87 | 7.40 |

If, on the other hand, experiment no. 2 reported above is taken into consideration, the values are as follows:
Costs=EUR 2.00
Revenues=EUR 9.61

Costs and revenues vary according to the composition of the samples and the variability of prices over time. The reagent prices and current gold and copper prices have been taken into account here. The price of gold was considered to be equal to EUR 35/g and that of copper equal to EUR 5.50/kg.

### Advantages of the Invention

Among the advantages of the invention, one may list the following:

1. use of a sample consisting of parts of electronic circuit boards, those containing gold, and not whole circuit boards; this reduction in sample weight and volume, with the same recoverable gold, results in a significant reduction in reagent costs;

2. high purity of gold obtained (98% on average) and good purity of copper (95-96%);

3. use of fairly diluted solutions of nitric and hydrochloric acid for the solubilization of the sample, which have an impact on cost reduction;

4. all development steps of the method are conducted at room temperature; the maximum temperature (50-55%) is reached in only two exothermic reactions; this fact considerably reduces the risks in case of accidental spillage of the solutions;

5. the solubilization of gold is obtained without active heating, the process being acid attack on the exothermic metal;

6. the final solution is a by-product and not a waste product: it may be used as fertilizer in fertigation or—when suitably diluted—as foliar fertilizer, and the possible sale to companies that produce fertilizers becomes a source of revenue, even if a modest one;

7. there is no dispersion of hazardous gases and vapors into the atmosphere as these are conveyed into a vessel of water, transforming them into an acid solution to be reused (diluted nitric and hydrochloric acid): this solution clearly meets environmental requirements; and

8. there is therefore no waste to dispose of.

In the foregoing, the preferred embodiments have been described and variants of the present invention have been suggested, but it is to be understood that the persons skilled in the art will be able to make modifications and changes without departing from the related scope of protection, as defined by the accompanying claims.

1. A method for recovering gold, comprising the following steps:
A. preparing a sample of gold-containing components in a reaction vessel;
B. pouring on said sample a volume of an aqueous solution comprising concentrated HNO₃, in a percentage ranging from 28% to 38%, and concentrated HCl, in a percentage ranging from 15% to 25%, so as to cover said sample;
C. simultaneously with step B., immersing the reaction vessel into a water bath at a water bath temperature below room temperature for a time ranging from 8 to 12 minutes;
D. keeping the water bath of step C. at room temperature for a time ranging from 27 to 40 minutes;
E. decanting said aqueous solution from said reaction vessel to a different vessel;
F. performing at least one washing of the sample, remaining in said reaction vessel after step E., with water to remove any portions of said aqueous solution adhering to the sample, washing water being added in said different vessel, measuring a final volume V_{T} of the aqueous solution in said different vessel;
G. boiling the aqueous solution resulting from step F. until its volume is reduced to a predetermined level, bringing it to room temperature and adding water at room temperature until a total volume greater than or equal to the final volume V_{T} is obtained;
H. gradually adding a solution of at least one hydroxide to the solution obtained from step G. until it reaches a pH between 0.5 and 0.9;
J. adding an amount of ascorbic acid C₆H₈O₆ dissolved in water at least equal to an amount of gold hypothetically present in said sample of step A. multiplied by a factor ranging between 1.5 and 3;
K. allowing gold to precipitate in the solution of step J. to settle; and
L. separating the precipitated gold of step K. from the solution of step K.

2. The method of claim 1, wherein said volume of aqueous solution of step B is calculated by multiplying the weight of the sample by a factor between 1.05 and 1.15.

3. The method of claim 1, wherein step K lasts at least two hours.

4. The method of claim 1, wherein step L. comprises the following sub-steps:
L1. decanting the solution present at the end of step K. to a further vessel, without pouring out the precipitated gold;
L2. washing with distilled water, termed “washing water”, the precipitated gold remained in said different vessel;
L3. decanting the washing water of step L2. and eliminating it; and
L4. heating the reaction vessel to a temperature of at least 200-300° C., or filtering gold and calcinating the filter, in order to separate powdered gold.

5. The method of claim 1, wherein the following steps are carried out after step L., in order to recover copper from said sample:
RA1.determining the amount of solubilized copper in the solution of step L., termed “copper solution”;
RA2.adding, to the copper solution, 1:1 HNO₃ in an amount equal to a percentage ranging from 5% to 10% of the volume of the copper solution;
RA3.adding, to the solution resulting from step RA2., iron filings or powder according to the ratio of atomic weights of copper and iron and based on copper amount determined in step RA1.;
RA4.waiting for precipitation of copper in the solution of step RA3.; and
RA5.separating the precipitated copper from the solution of step RA4.

6. The method of claim 5, wherein step RA1. is carried out photometrically, using ammonia and ability of ammonia to form with copper a complex with a light-blue color directly proportional to copper concentration.

7. The method of claim 5, wherein step RA5. comprises the following sub-steps:
RA6. performing a washing of the precipitated copper with water, termed “copper washing water” and heating until boiling;
RA7. as soon as boiling begins, stopping heating and allowing precipitation;
RA8. decanting the copper washing water into the solution of step RA4.; and
RA9. heating copper obtained in step RA7 until copper obtained in step RA7. dries.

8. The method of claim 5, wherein after step RA5. the following steps are carried out:
RA10.adding hydrogen peroxide to the solution obtained from the separation, at a concentration ranging from 2% to 5%;
RA11.adding a solution of at least one hydroxide at a concentration ranging from 15% to 25% by volume to obtain a pH value ranging between 1.5 and 1.9; and
RA12.diluting the solution obtained in step RA11. with water until the pH value ranges between 1.9 and 2.3; the solution obtained in step RA12. being usable as a liquid fertilizer.

9. The method of claim 1, wherein step A. is carried out by eliminating parts not containing a predetermined amount of gold from said gold-containing components, and cutting remaining parts into pieces of similar size.

10. The method of claim 1, wherein in steps C. and D. the reaction vessel is closed by an apparatus which conveys reaction gases into a separate water vessel.

11. The method of claim 1, wherein after step L. the following steps are carried out:
M. immersing the separated gold of step L. into a mixture consisting of about 25-35% 1:1 HNO₃ and of about 75-65% 1:1 HCl;
N. heating the mixture of step M. until boiling;
O. as soon as gold is solubilized, cooling the mixture and diluting it with distilled water;
P. filtering the solution of step O.;
Q. adding L-ascorbic acid dissolved in water at 1:1.5 with respect to an estimated amount of gold present in the mixture; and
R. once gold has precipitated in the mixture, separating gold from the mixture.

12. The method of claim 1, wherein the water bath temperature of step C. is between 5° C. and 10° C.

13. The method of claim 1, wherein in step H. said at least one hydroxide consists of or comprises KOH.

14. The method of claim 1, wherein between step H. and step J. the following step is carried out:
I. filtering the solution obtained from step H.

15. The method of claim 1, wherein said gold-containing components are electrical and/or electronic components.

16. The method of claim 1, wherein in step G. the total volume V_{T} is between an initial volume and 1.5 times the initial volume.

17. The method of claim 1, wherein in step H. the hydroxide solution has a concentration varying from 20% to 50%.

18. The method of claim 1, wherein step K. lasts at least three hours.

19. The method of claim 10, wherein said separate water vessel is made of glass.

20. The method of claim 8, wherein in step RA11, said at least one hydroxide consists of or comprises KOH.

21. The method of claim 4, wherein the following steps are carried out after step L., in order to recover copper from said sample:
RA1.determining the amount of solubilized copper in the solution of step L1., termed “copper solution”;
RA2.adding, to the copper solution, 1:1 HNO₃ in an amount equal to a percentage ranging from 5% to 10% of the volume of the copper solution;
RA3.adding, to the solution resulting from step RA2., iron filings or powder according to the ratio of atomic weights of copper and iron and based on copper amount determined in step RA1.;
RA4.waiting for precipitation of copper in the solution of step RA3.; and
RA5.separating the precipitated copper from the solution of step RA4.

22. The method of claim 11, wherein step R. is carried out by plate heating.
